(19) United States
(12) Patent Application Publication
(10) Pub. No.: US 2016/0307390 A1
(43) Pub. Date: Oct. 20, 2016

(54) Rotary Dispensing Mechanism For Vending Machines

(71) Applicant: Automated Mechandising Systems Inc., Kearneysville, WV (US)

(72) Inventor: Paul Mason, Inwood, WV (US)

(21) Appl. No.: 14/690,261

(22) Filed: Apr. 17, 2015

(51) Int. Cl. G07F 11/24; G07F 11/10; G07F 11/52

(52) U.S. Cl. CPC G07F 11/24; G07F 11/52; G07F 11/10

(57) ABSTRACT

A vending machine dispenser mechanism in the form of a roller for receiving and dispensing bottles or cans from a vertical stack. The roller dispensing mechanism comprises a driven roller having a roller support at each end which are supported by horizontally extending front and rear support members each of which include a plurality of spaced apart apertures in which the roller supports are rotatably mounted. The apertures can include keyhole shaped openings in each of the support members, a combination of keyhole and circular openings, or various other aperture shapes and combinations which together permit fast and easy roller installation and removal. The dispensing rollers contain two or more slots or pockets, or sub-pockets, that will sequentially receive and dispense a bottle or can one at a time in a controlled and positive manner as the roller is driven through a plurality of specific degrees of rotation.

### CROSS-REFERENCE TO CO-PENDING APPLICATIONS

The present invention is related to the following co-pending U.S. Patent applications which is all commonly owned with the present application, the entire contents thereof being hereby incorporated herein by reference thereto: U.S. patent application Ser. No. 14/684,904, entitled “Double Thick Vending Machine stack Wall,” filed on Apr. 13, 2015; and U.S. patent application Ser. No. 14/684,965, entitled “Vending Machine Adjustable Depth Retainer,” filed on Apr. 13, 2015.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD OF THE DISCLOSURE

This disclosure relates to structures used in vending machines for dispensing selected products from a stacked set or array of products held or retained there above and within a product holding area of a vending machine.

### INTRODUCTION

This invention relates to vending machines, and in particular, to vending machines that can be stocked with vertical stacks of vendable products and with vertical stacks of products retained in columns in a product storage area therein.

Vertical stacks are one way to store and dispense products in vending machines and for many products is an efficient and effective way to store a maximum number of products. This is an important as the more items that can be stored in the machine the less often is the need to restock.

In a vending machine, internal column walls are employed to define product storage magazines or zones. More specifically, a series of column walls are arranged at spaced positions within a vending cabinet and serve as partitions to contain, separate, and support a stack of products to be dispensed.

The present invention has been designed to dispense cans or bottles held in such stacked columns in an orderly and controllable fashion.

There are a variety of vending dispensing techniques, but the present invention provides a positive vend, of one can or bottle at a time, it can dispense from multiple columns of stacked products, the dispensing mechanism is easily installed, replaced and permits a maximum of stacked bottles or cans to be held yet easily dispensed.

### DESCRIPTION OF PRESENTLY PREFERRED EXAMPLES OF THE INVENTION

### BRIEF DESCRIPTION OF FIGURES

The invention is better understood by reading the following detailed description with reference to the accompanying drawings in which:

FIG. 1 is a frontal perspective showing the outside of a vending machine;

FIG. 2 is a cross sectional view of the inside of a vending machine taken along line 2-2 in FIG. 1;

FIG. 3 is a partial frontal perspective showing a portion of the product holding area of a vending machine including several of the plurality of stacking walls, several of the plurality of product compartments, and one of the dispensing mechanisms described herein;

FIG. 4 is a an enlarged view of one end of a product dispensing roller and the drive motor and is connection to the roller;

FIG. 5 is a perspective view of a two pocket dispensing roller;

FIG. 6 is top plan view of the roller shown in FIG. 5;

FIG. 7 is a longitudinal cross sectional view thereof;

FIG. 8 is a cross sectional view taken along line 8-8 in FIG. 7;

FIG. 9 is a cross sectional view taken along line 9-9 in FIG. 7;

FIG. 10 is a cross sectional view taken along line 10-10 in FIG. 7;

FIG. 11 is a perspective view of a four pocket dispensing roller;

FIG. 12 is top plan view of the roller shown in FIG. 11;

FIG. 13 is a longitudinal cross sectional view thereof;

FIG. 14 is a cross sectional view taken along line 14-14 in FIG. 13;

FIG. 15 is a cross sectional view taken along line 15-15 in FIG. 13;

FIG. 16A shows a diagrammatic cross section of one embodiment for a bottle roller mounting technique;

FIG. 16B shows a diagrammatic cross section of one embodiment for a can roller mounting technique;

FIG. 17 shows a diagrammatic cross section of an alternative mounting arrangement for a two compartment roller ;

FIG. 18 shows a two pocket roller at a 0° position;

FIG. 19 shows a two pocket roller at a 15° position;

FIG. 20 shows a two pocket roller at a 90° position;

FIG. 21 shows a two pocket roller at a 195° position;

FIG. 22 shows a two pocket roller with sub compartments for cans each at a 0° position;

FIG. 23 shows a diagrammatic cross sectional view of the roller in FIG. 22 with the front two compartments filled;

FIG. 24 shows the roller of FIG. 22 at a 135° position;

FIG. 25 shows the roller of FIG. 22 at a 180° position;

FIG. 26 shows the roller of FIG. 22 at a 315° position;

FIG. 27 shows the roller of FIG. 22 once again back at a 0° position;

FIG. 28 shows a diagrammatic cross sectional view along line 28-28 in FIG. 27 showing a partial stack of cans with the bottom most can being retained in a pocket at a 0° roller position and product control flaps;

FIG. 29 shows the same diagrammatic cross sectional view as in FIG. 28 in which a first can being dispensed at a 135° roller position while a second can is being retained by a product control flap; and

FIG. 30 shows the same diagrammatic cross sectional view as in FIGS. 28 and 29 in which a second can is being dispensed at a 180° roller position.

### DESCRIPTION

### A. Overview

To gain a better understanding of the invention, a preferred embodiment will now be described in detail. Frequent reference will be made to the drawings. Reference numerals or letters will be used throughout to indicate certain parts or locations in the drawings. The same reference numerals or letters will be used to indicate the same parts and locations throughout the drawings, unless otherwise indicated.

### B. Environment

The preferred embodiment now described will be with respect to a vending machine and in particular to a product dispensing roller mechanism that can be installed and removed with relative ease relative to the interior of a vending machine The scale of the embodiment, therefore, is to be understood with respect to this type of article.

### C. Structure

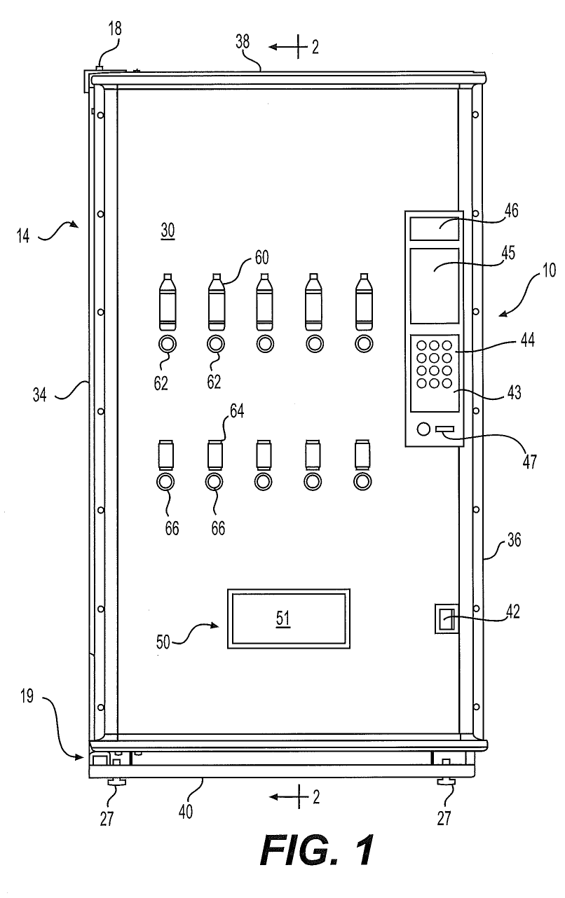

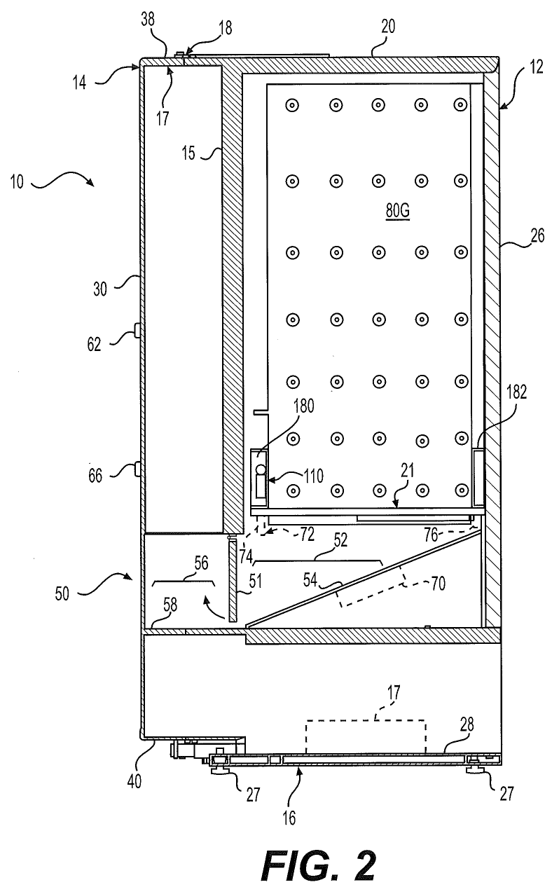

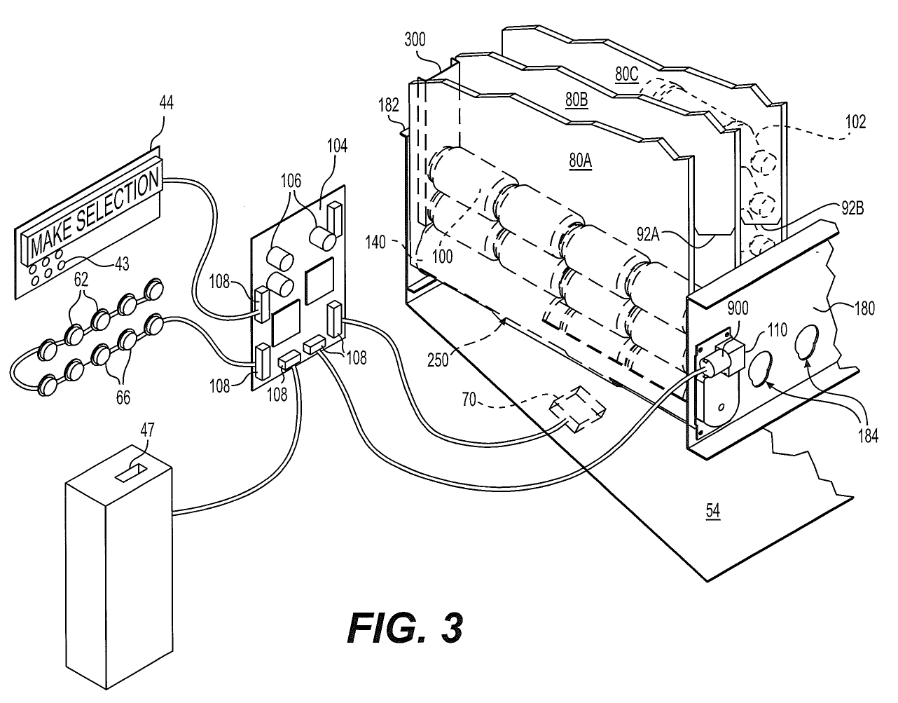

FIGS. 1 and 2 show such a closed front vending machine 10 as being comprised of a case or cabinet 12 that includes a front door 14 and a rear cabinet 16. Front door 14 is pivotally mounted to the rear cabinet by top and bottom hinges 18 and 19, respectively. Front door 14 includes an inner door 15 that can be pivotally attached either to an inside portion of an outer portion 17 of the front door, or to the rear cabinet 12, and in either case by hinges (not shown). The outer portion 17 is designed to overly the inner door 15 with the latter being an insulating door that will close over the front of the product holding section 21, as shown in FIG. 3, to keep the contents of a product holding section 21 cold when vending cold or frozen products. The vending equipment 10 can also include a suitable refrigeration unit 17, as shown in FIG. 2, to maintain desired temperatures within the product holding section 21.

With reference to FIGS. 2 and 3 the main rear cabinet is 16 that is itself comprised of separate top wall 20, opposing side walls, a rear wall 26 and a bottom wall 28, as well as a plurality of height adjustable feet 27. The front door 14 and the rear portion 16 collectively define the outer casing structure 12 for the vending machine 10.

The front door 14 includes a front panel 30 that is retained in a frame formed from opposing sides 34 and 36, a top 38 and a bottom or base plate 40. Door 14 also includes and supports a coin changer including a change return 42, a suitable keypad 43, a control panel 44, a display 45, a coin acceptor and return assembly 47, and a retrieval door mechanism 50. Door 14 has sufficient internal space to mount other parts of the vending machine such as, for example, control electronics, the coin changer assembly, a bill validator 46, or other devices as may be desired. The front panel 30 can also include exemplary bottles 60 and bottle selection buttons 62 and exemplary cans 64 and can selection buttons 66.

The vending machine 10 includes a product holding section 21, as shown in FIG. 3, that can be comprised of a plurality of spaced apart product containment or stacking walls, three of which are shown at 80A-80C, which are discussed in the above identified co-pending applications, which have been incorporated herein by reference thereto. Adjacent ones of these stacking or containment walls, for example 80A and 80B will serve to form there between a product holding compartment for example as shown at 92A in FIG. 3 and compartment 92B which is defined between stacking walls 80B and 80C. These product holding compartments 92A and 92B can hold vertically extending stacks of cans, for example as shown in compartment 92A at 100 in FIG. 3 or bottles 102 in compartment 92B. Also shown in FIG. 3, and other figures herein, each compartment 92A and 92B can include an adjustable rear wall 300 that is described in detail in the co-pending patent application Ser. No. 14/684,965, that is incorporated herein in its entirety by reference thereto.

Located below the product holding section 21 is a drop zone area 52 at the bottom of which is a product directing ramp or panel 54 that is an angled sheet, for example of metal or plastic, whose angle of inclination from back to front will direct a dispensed product falling from the product holding section 21 forwardly through a swinging door 51 that can, for example, be pivotally mounted below insulated interior wall 15 so as to swing outwardly and permit the dispensed product to roll or otherwise move toward a front product retrieval area 56 and onto floor 58 thereof from which the dispensed product can be retrieved via an opening in the door 14.

The vending machine 10 can also include a suitable vend detection or sensing system. One such system, as shown in phantom at 70, is a vibration sensor attached to the bottom side of ramp or plate 54 to sense when a product has fallen onto that ramp or plate 54. A vend sensing system could also be of an infrared type as is diagrammatically shown generally at 72 in FIG. 2 and includes suitable emitter/detector units, 74/76, respectively, extending along each of the two opposing sides or ends of the space or drop zone 52, which will create a plane of infrared radiation operating across the depth and width of the drop zone 52 so that along with suitable control equipment the system will sense passage of a dispensed product falling through the field of radiation.

FIG. 3 shows a partial view of the internal product holding area with parts having been cut away for clarity. FIG. 3 also shows a selection panel 44 along with the key pad 43, the selection buttons 62 and 66, a control board 104 that includes various control interface components 106 and electrical connections 108, including, for example, the control panel 44, the key pad 43, the coin acceptor assembly 47, the drop sensor 70, and drive motor assemblies 110 that will drive dispensing rollers, one of which is shown in phantom at 140. FIG. 3 also shows a holding flap 250 that is attached to and extends below a limited portion of the bottom of stacking wall 80A, as well as the roller support structure, and both will be more fully discussed hereinafter.

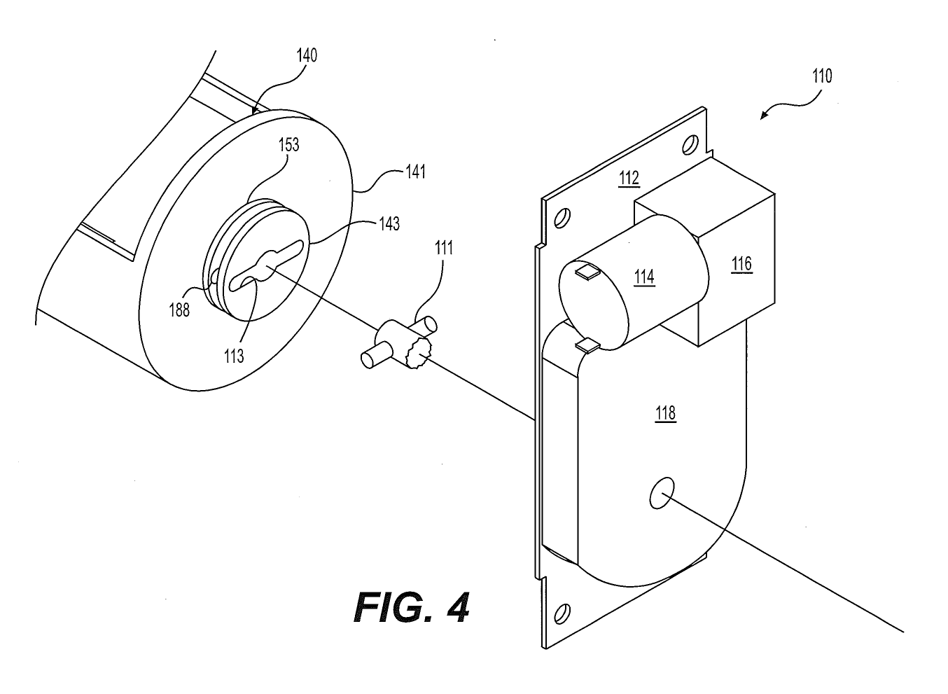

FIG. 4 shows an enlarged view of one of the dispensing rotor drive motors 110 as including a mounting frame 112, an electric motor 114 as well as driven gearing assemblies 116 and 118. One end 141 of dispensing roller 140 is also shown along with outwardly extending cylindrical member 143 that includes a drive slot 113 centrally positioned thereon and that is shaped to receive the drive member 111 of the motor assembly 110, and an outer surface 153 that will provide rotational support for one end of roller 140.

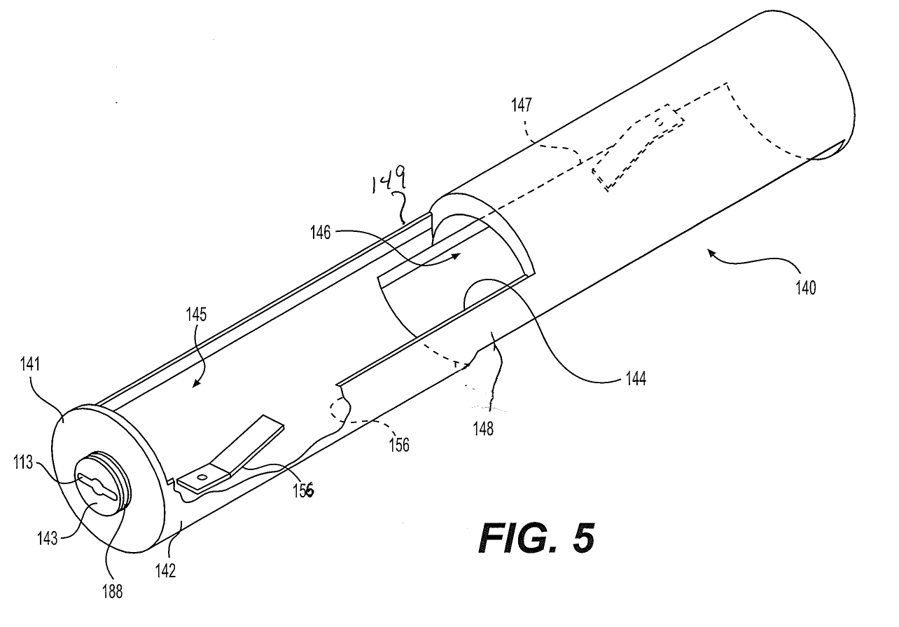

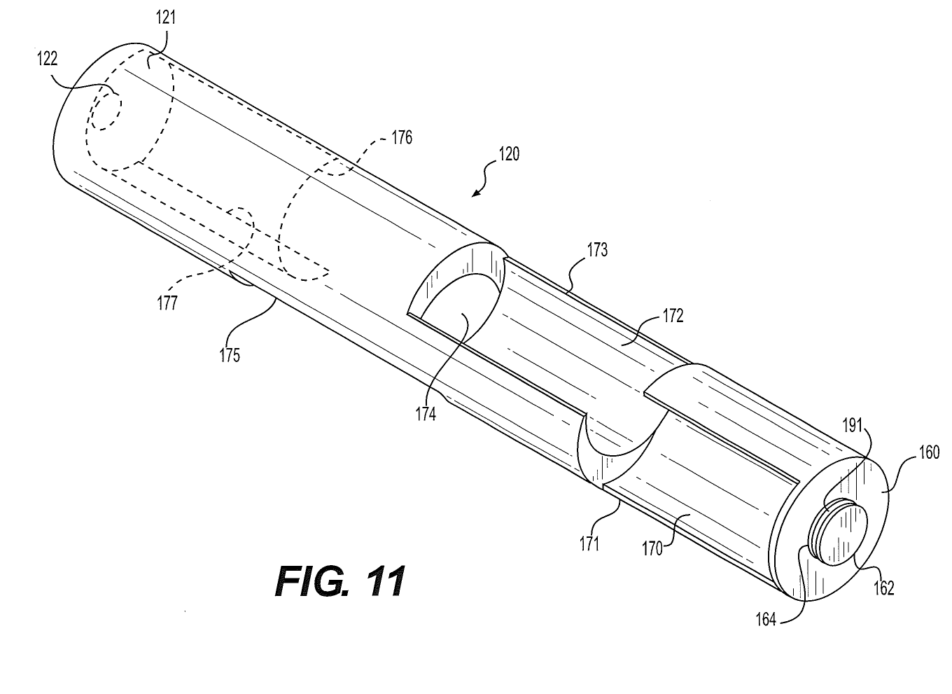

FIGS. 5-10 show a two pocket or slot dispensing roller while FIGS. 11-15 show a four pocket or slot dispensing roller.

Turning first to FIGS. 5-10 a two pocket dispensing roller 140 includes an outer cylindrical body 142 with its left or front end, as shown, including an end or front wall 141 having an outwardly extending cylindrical roller support member 143 formed centrally thereon. The cylindrical body 142 includes an opening 144 to a first and front pocket or slot 145 that extends axially for a distance that is slightly more than half of the length of the roller 140. A portion of a second or rear pocket or slot 146 is partially visible through the front pocket 145 and the remainder of the second or rear pocket 146 is shown in phantom with the opening thereto 147 being located approximately 180 degrees from the first opening 144 into the front pocket 145. As can be seen in FIG. 5 there is an overlapping of the two front and rear pockets 145/146, with a narrow portion of the cylindrical body 142 extending there along on each side of the over lapping area as shown at 148 and 149.

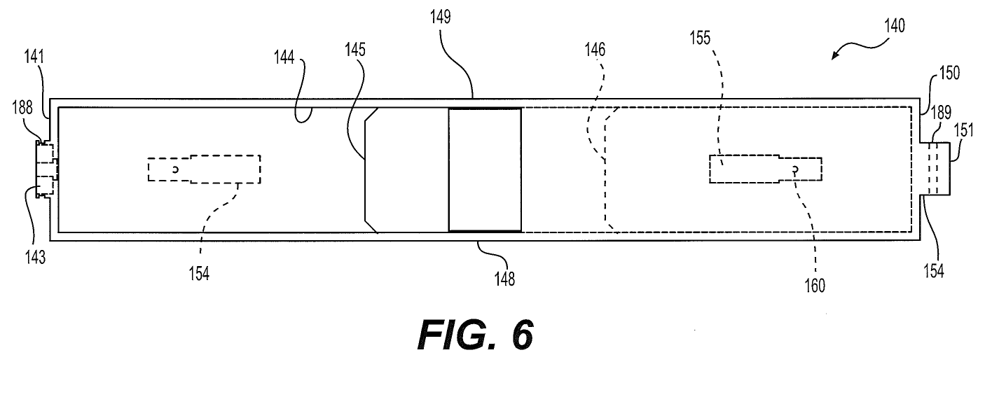

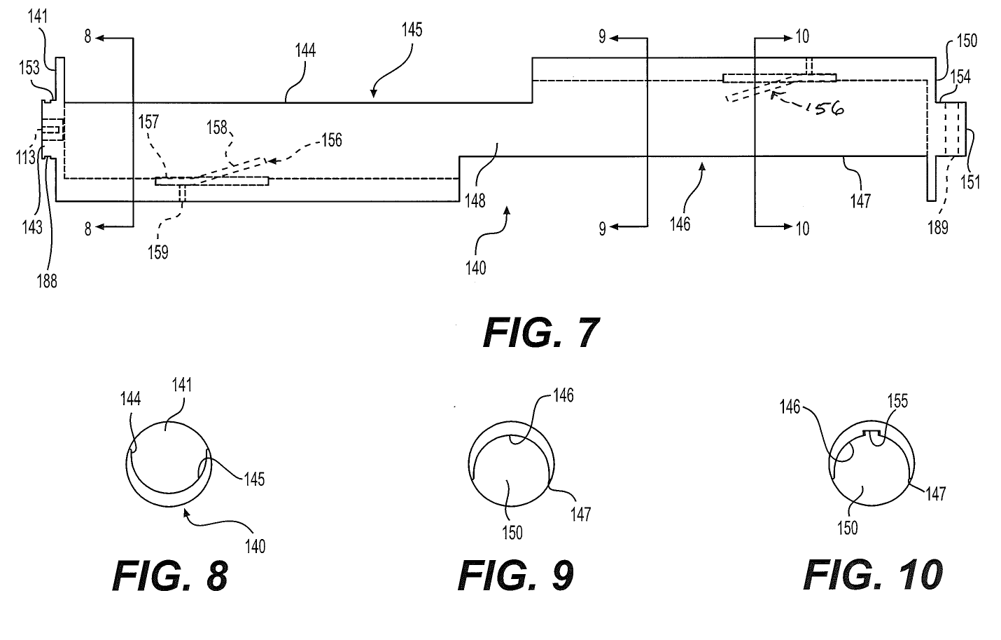

FIGS. 6 and 7 show both a first front pocket 145 and a second or rear pocket 146 as well as the over lapping portion. FIGS. 6 and 7 also show a right side end wall 150 having an outwardly extending cylindrical roller support member 151. The outer surfaces 153 and 154 of the cylindrical roller support members 143 and 151, respectively, will form bearing surfaces by which the roller 140 will be supported and on which it will rotate.

When vending cans using this two pocket roller design two cans can share the same pocket. In that case it is possible for one can to slide axially once a first can is vended if the machine is rocked. A solution to this potential issue is to provide an axially extending groove 154 and 155 on an inside portion of each pocket 145 and 146, spaced about 2.325 inches in from the end walls, and each groove 154/155 will receive and support a spring clip 156 therein comprised of a flat section 157 and a raised portion 158. Spring clip 156 is held in place by a post or pin 159 that extends downwardly from the flat section 157 and fits into a socket 160. Spring clips 156 will prevent a can from sliding axially pocket to the other. For example, if rotor 140 had been rotated so that the second can back from one end is vended from pocket 146 the rear-most can is still retained. However, should someone then rock the vending machine the rear-most can might slide axially from where it was held and then out through the same opening 146 through which the previous can had just been dispensed. Spring clip 156 will prevent this axial sliding from happening as the raised portion 158 will place a force on the front most can to hold it in place.

FIGS. 8-10 show various cross sectional views at lines 8-8, 9-9 and 10-10 in FIG. 7. In FIG. 8 pocket 145 is in upward position ready to receive a can or bottle. In FIG. 9 pocket 146 is in a downward position form which a can or bottle could have just been dispensed. FIG. 10 looks to the right and shows the recess 155 into which spring clip 156 will be received.

The roller 140 is designed to work, as one example, with two 24 ounce bottles, that have a 2.88 inch diameter, as well as four 12 ounce cans that have a 2.59 inch diameter. The pocket openings 144 and 147 are preferably about 2.95 inches wide and the outer diameter of roller 140 is preferably about 3.35 inches. The overall length of roller 140 is 20.5 inches and the axial length of pockets 145 and 146 is about 9.4 inches measured from each end 141 and 150, respectively, making the axial length of the overlap area about 1.7 inches. It should also be understood that the depth of the pockets 145 and 146 are designed so that the outer surface of a can or bottle retained therein will be aligned with the outer circumference of the roller 140. In this way rotation of roller 140 and the retained cans or bottles will smoothly rotate under the remaining stack there above and will not lift that stack of cans or bottles.

FIGS. 11-15 show details of the four pocket dispensing roller 120 shown previously in FIG. 3. FIG. 11 shows a front end wall 160 from which a cylindrical member 162 extends with its outer surface 164 providing a bearing surface supporting roller 120. That outer surface 164 can also be provided with a rotation support groove 191. At the rear end of roller 120 is a rear end wall 121 from which a cylindrical roller support member 122 extends. That cylindrical roller support member 122 can have an outer surface 125 that could also be provided with a roller support groove 190. Further, the cylindrical member 162 can also be provided with a drive slot 152 which can be operatively connected to a motor drive member 111 as shown previously in FIG. 4.

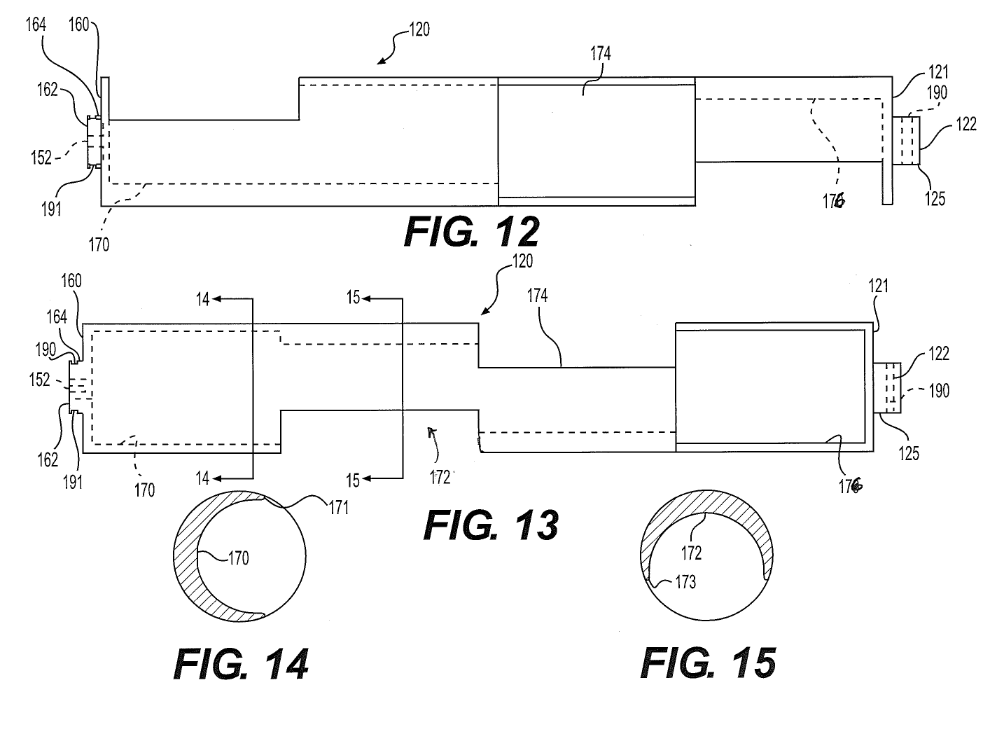

Roller 120 includes four pockets and from right to left in FIG. 11 those pockets are 170, 172, 174 and 176 with the openings thereto being shown at 171, 173, 175 an 177, respectively. The four pocket roller 120 has been designed exclusively for 12 ounce cans and the outer diameter is about 3.2 inches and each pocket is about 2.7 inches wide. The roller 120 has an overall length of 21.5 inches, and each opening has an axial length of about 6 inches. FIGS. 12 and 13 show the locations of the four pockets 170, 172, 174 and 176, the end cylindrical members 122 and 162 end walls 121 and 160, and the relative positions for the pockets.

FIGS. 14 and 15 show cross sectional views at 14-14 and 15-15 in FIG. 13 and these are similar to the cross sectional views of the two pocket roller but with slightly different dimensions as noted above.

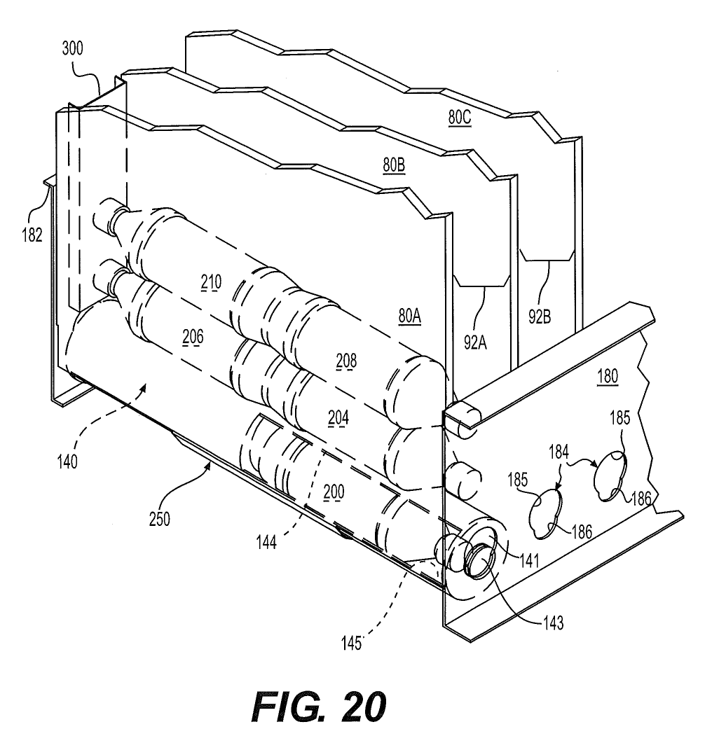

With reference again to FIGS. 2 and 3 there are a front and rear support roller members 180 and 182 that are connected to the vending machine frame so as to extend horizontally across the front and back, respectively, of the bottoms of stacking walls 80A-80C. Each support member 180/182 includes a plurality of apertures in which the dispensing rollers will be installed and within which they will rotate. One such an aperture is shown, for one example, in FIG. 20 at 184 which has an enlarged upper portion 185 and a smaller diameter lower portion 186 with portions 185 and 186 defining what can be referenced as a keyhole form of an opening The upper portion 185 has a larger diameter than the cylindrical members 122/162 for roller 120 and 143/151 for roller 140 while the smaller diameter lower portion 186 will receive the outer surface 125/164 for roller 120, and 153/154 for roller 140 of its cylindrical members ‘143/151, respectively. It is also possible, as was described previously, to form a groove shown at 190/191 in the outer support surfaces 125/164, respectively for roller 120, and to also form grooves in cylindrical roller support members 143/151, for roller 140, as shown at 188 and 189, respectively, that would slidably interfit with the peripheral edges of the lower portion 186 of the key hole type apertures 184.

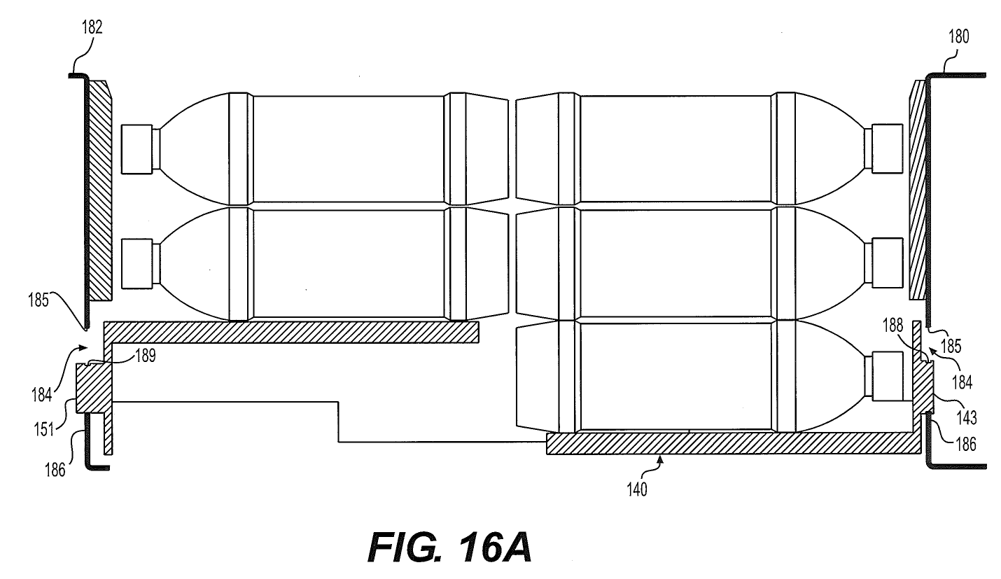

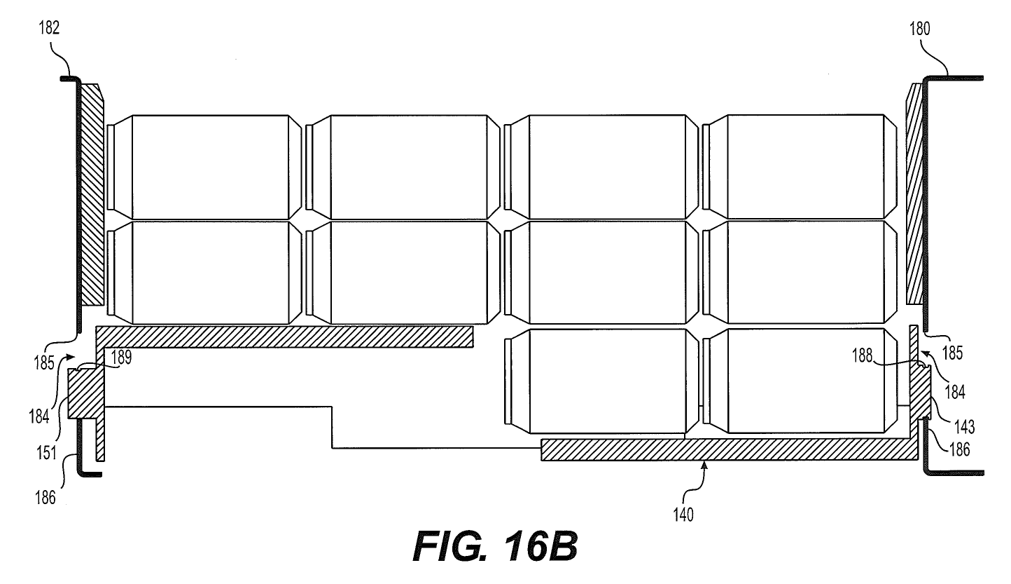

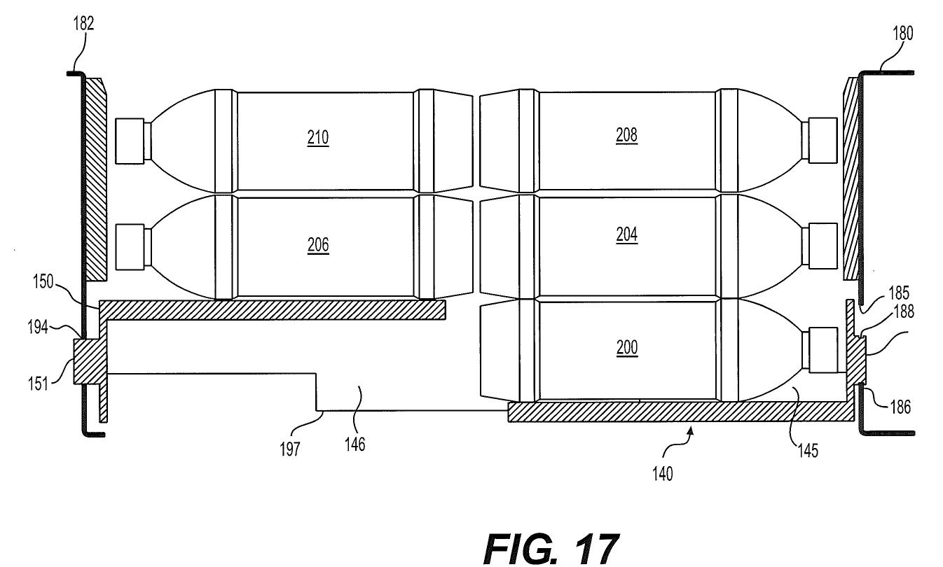

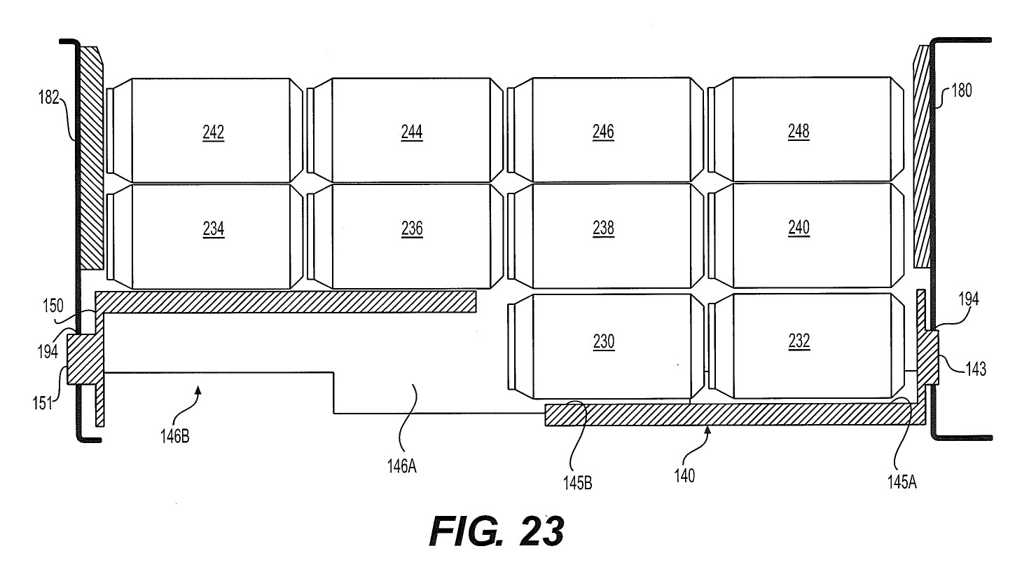

The rear cylindrical roller support members can be rotatably supported by one of several approaches. One as shown in FIG. 16A for bottles provides a plurality of spaced apart keyholes 184 in the rear support member 182 into which the rear cylindrical roller support members 151 for rollers 140 or 122 for rollers 120 can be installed as described above. Alternatively, as shown in FIG. 17 roller 140 dispensing bottles, and in FIG. 23 for roller 140 dispensing cans the rear cylindrical roller support member 151 for roller 140, or likewise for the rear cylindrical roller support member 122 for roller 120, can be axially slid into a circular aperture 194 which has a diameter close to but slightly larger than cylindrical roller support members 151/122.

Using either of these mounting arrangements permits a roller 120 or 140 to be easily installed by simply placing the rear cylindrical roller support member 151/122 into one of the plurality of apertures in the rear support member 182 and then placing the front cylindrical roller support member 143/162 axially into the upper opening 185 and then dropping the slot 188/190 vertically into the lower opening 186 and the roller is installed. Removal is simply the reverse of raising the front end of roller 140/120 to disengage slot 188/190 from the lower opening 186 and once the cylindrical roller support member 143/162 was within the upper opening 185 the roller 140/120 can be slid axially out of the front support member 180.

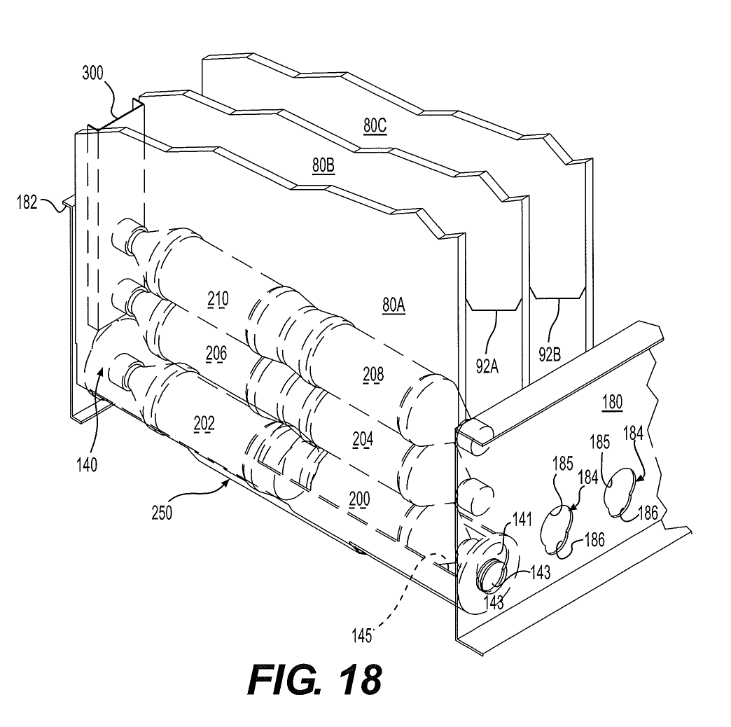

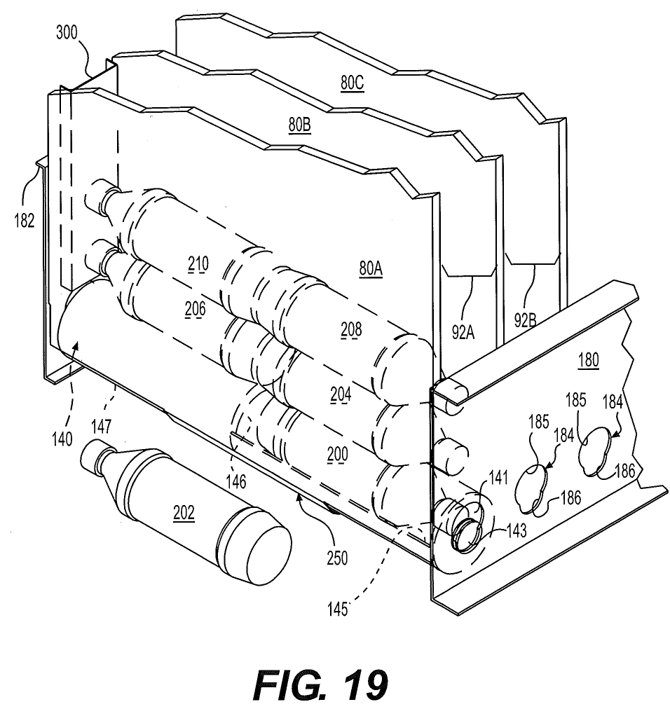

With reference to FIGS. 18-21 the rotation sequence of the two pocket roller can be appreciated. In FIG. 18, which shows roller 140 in a 0° position, a bottle 200 has been received by or has dropped into the foremost pocket 145, and a second bottle 202 had previously been received in the rear most pocket 146. As roller 140 is rotated to a 15° position as shown in FIG. 19 the rear most bottle 202 has now been dispensed from pocket 146 by falling through opening 147.

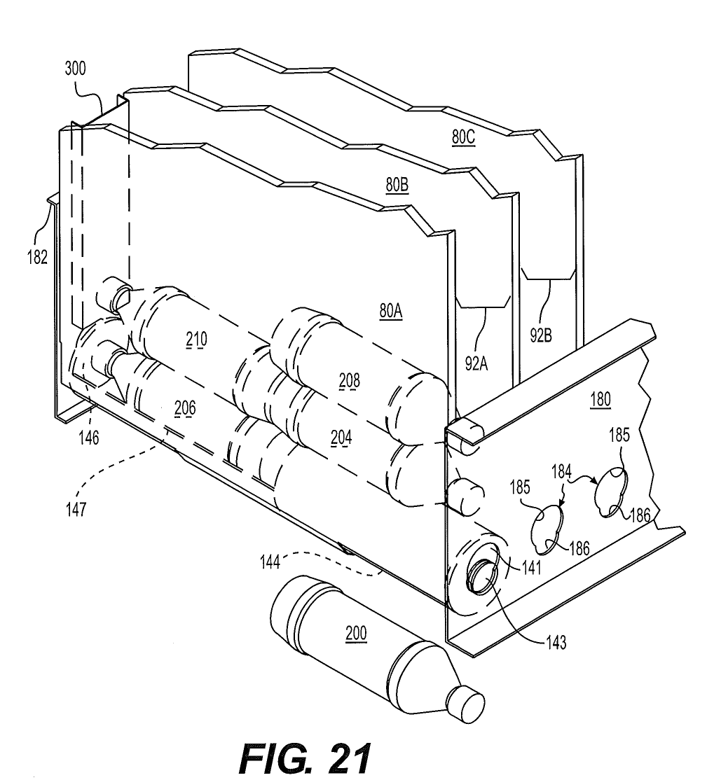

In FIG. 20 roller 140 has been further rotated to a 90° position where the foremost pocket 145 has been further rotated but bottle 200 is still retained and has not yet been dispensed. Also, the next rear most bottle 206 has not yet been received within pocket 146. FIG. 21 shows roller 140 having been rotated to a 195° position. Here the foremost pocket will have been rotated sufficiently to permit the foremost bottle 200 to now be dispensed by falling through opening 144 and the next rear most bottle 206 has been received within the rear most pocket 146.

As the two pocket roller 140 continues to be rotated this cycling between receiving and dispensing foremost and rearmost bottles or cans will continue. It should also be understood that the drive motor assembly for roller 140 will, once a product has been selected and there has been confirmation that the correct payment has been received, continue to rotate roller 140 until a sensor has determined a product has been dispensed. That could be a signal form the vibration sensor 70 or from the infrared system 72/76. When such a signal is sensed the motor drive will then stop and further rotation of roller 140 will cease until the next vend cycle has been initiated.

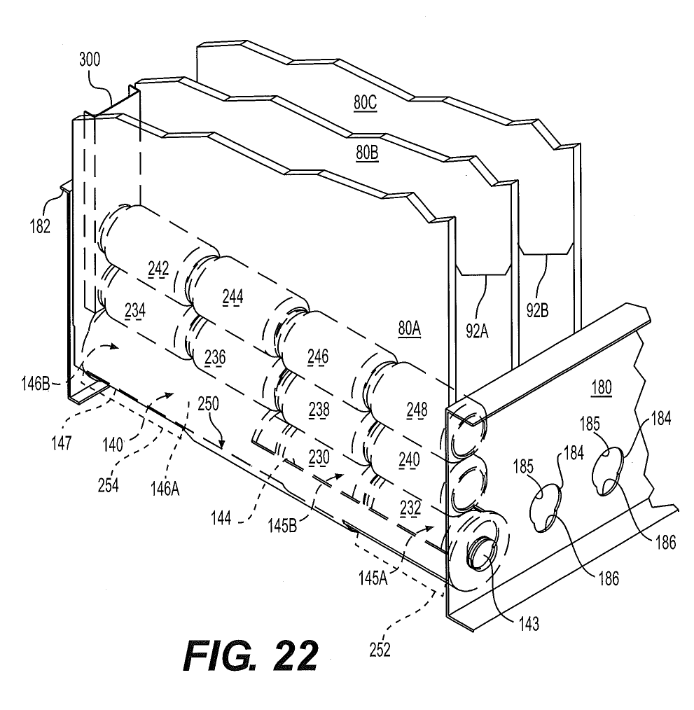

FIGS. 22-30 show a dispensing sequence where the two pocket roller 140 will dispense four axially positioned 12 ounce cans. For ease of an explanation each of the front and rear pockets in roller 140, 145 and 146 respectively, will each be sub divided into a pair of sub-pockets, with the fore most sub-pocket being 145A, the next rear most sub-pocket will be 145B, the next rear most sub-pocket will be 146A, and the rear or most rearward sub-pocket will be 146B. In this way four cans can be held in roller 140 using the four axially positioned sub-pockets 145A, 145B, 146A and 146B when looking from the front to the rear of roller 140.

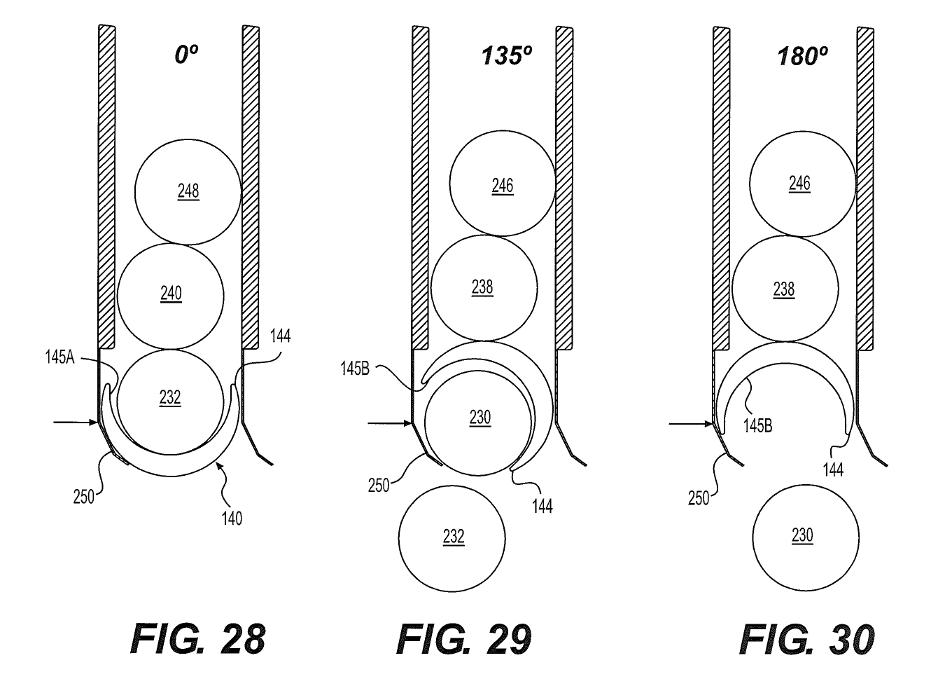

In FIG. 22 roller 140 is positioned at a 0° position which is also shown in cross section in FIGS. 16B and 23. The four sub-pockets are indicated there are no cans currently retained in pockets 146B and 146A, but can 230 is in pocket 145B and can 232 is in pocket 145A. FIGS. 28, 29 and 30 show the sequence that will be followed for cans 230 and 232.

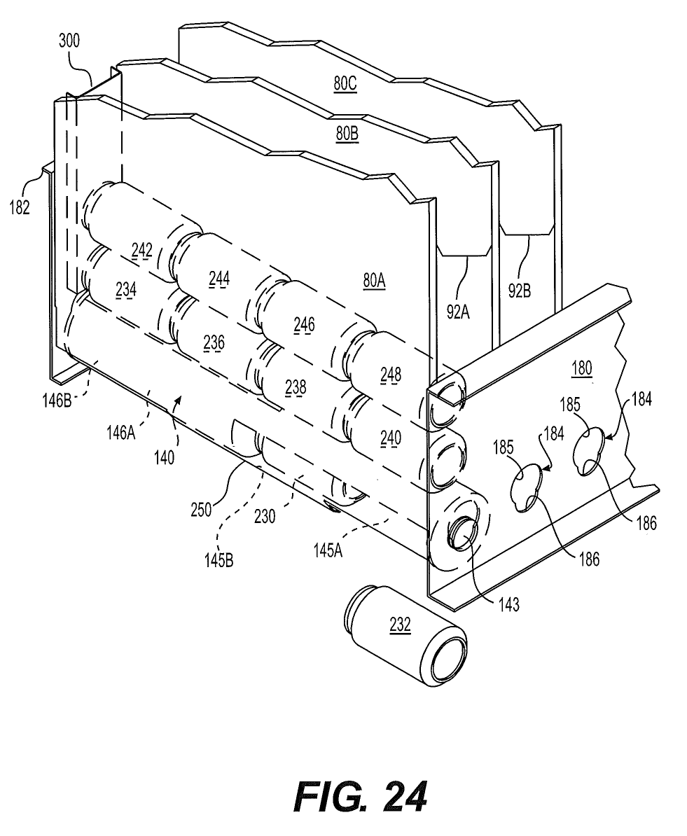

As roller 140 is rotated to a 135° position as shown in FIG. 24 the opening 144 of the foremost pocket 145A will be rotated so that the foremost can 232 will pass through opening 144. However, the next rear most can 230 will not be allowed to drop through its opening 144 and out of pocket 145B due to the presence of a flap member 250 which, along with the far edge of opening 144 of pocket 145B as shown in FIG. 29, will further retain that next rearmost can 230 within pocket 145B for another 45° of rotation of roller 140.

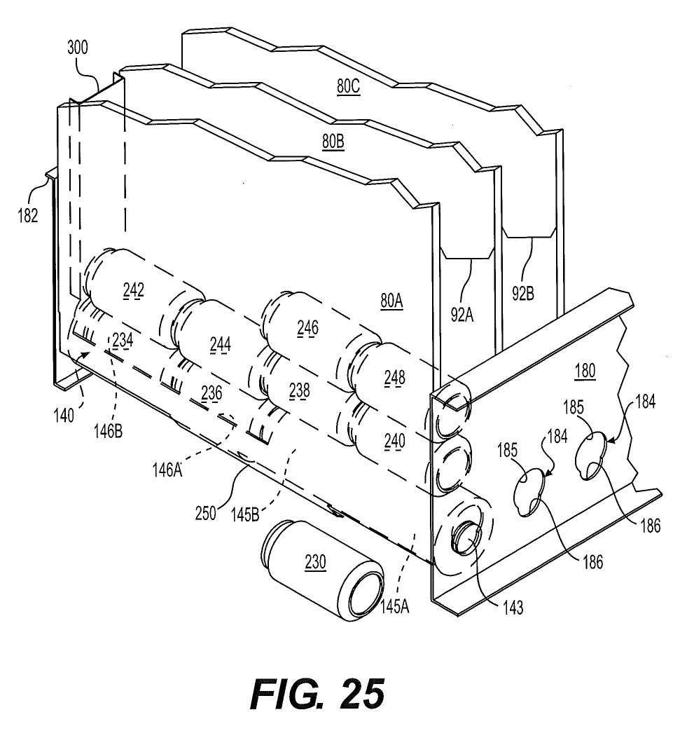

Roller 140 will then be rotated another 45° to a 180° position as is shown in FIGS. 25 and 30 where the flap 250 and the edge of opening 144 will release can 230 that will then drop onto plate 54 and be dispensed to a consumer. In this same 180° position the two rear most pockets 146A and 146B will now receive the next cans from the stacked column of cans remaining there above with cans 234 and 236 falling into pockets 146A and 146B, respectively.

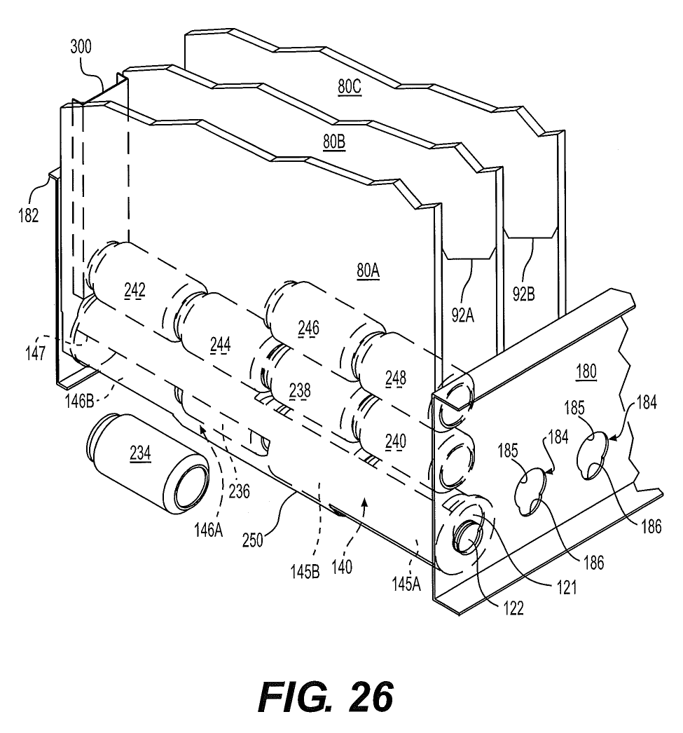

As roller 140 is next rotated to a 315° position as shown in FIG. 26, the rear most can 234 will be dispensed by falling through opening 147. However, as was the case for can 230 being further retained by flap 250 at the 135° position, as shown in FIG. 29, can 236 will also be further retained by flap 250 and an opposing part of opening 147, as was the case for flap and the opposing part of opening 144 in FIG. 29. Flap 250 will work to accomplish the further retaining of the middle positioned cans within pockets 145B and 146A as flap 250 extends a sufficient distance axially to span those middle two sub-pockets 145B and 146A. It should be understood that the dispensing delay flap 250 could be divided into two spaced apart flaps as is shown in phantom at 252 and 254 in FIG. 22 where flap 252 would work with the front most sub-pocket 145A and flap 254 would work with the rear most sub-pocket 146B to permit the middle sub-pockets to dispense their cans at a point in time sooner than the adjacent front and rear most sub-pockets, and to delay the release of the cans from those sub-pockets 145A and 146B for another 45° degrees of rotation.

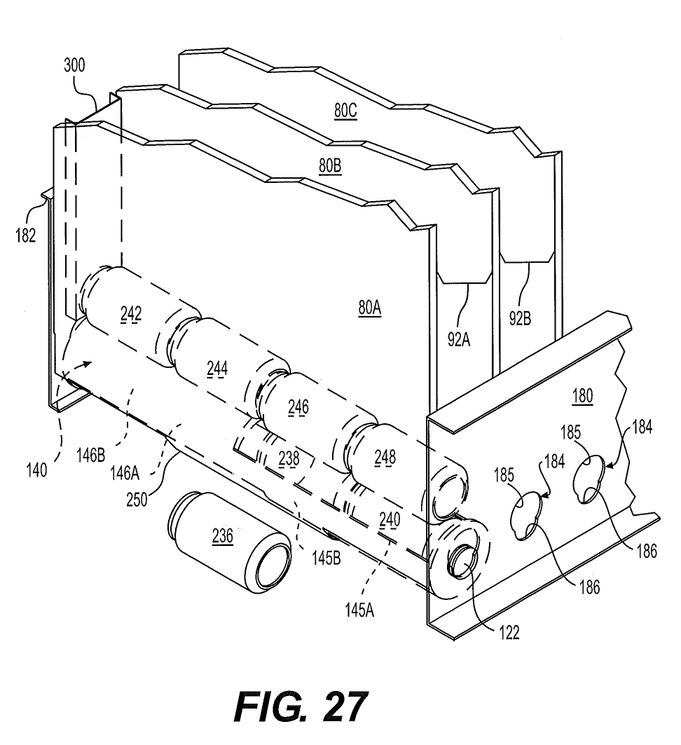

As the roller is then further rotated to again arrive back to a 0° position as shown in FIG. 27 the next fore most can 236 in sub-pocket 146A, that had been retained by flap 250, will be released, as was can 230 in FIG. 30, and can 236 will be dispensed.

The four pocket roller 120 has pockets 170, 172, 174 and 176 that will sequentially received cans from the stack of cans remaining there above and in a like manner dispense cans as roller 120 is rotated through various degrees of rotation. The circumferential spacing of the pockets 170-176 can be arranged at 90° offsets, or they can be located at 90°+/−30°, or at other degrees of offset depending upon the precise product being vended or the cycle desired for vending.

When introducing elements of various aspects of the present invention or embodiments thereof, the articles “a,” “an,” “the” and “said” are intended to mean that there are one or more of the elements, unless stated otherwise. The terms “comprising,” “including” and “having,” and their derivatives, are intended to be open-ended terms that specify the presence of the stated features, elements, components, groups, and/or steps, but do not exclude the presence of other unstated features, elements, components, groups, and/or steps and mean that there may be additional features, elements, components, groups, and/or steps other than those listed. Moreover, the use of “top” and “bottom,” “front” and “rear,” “above,” and “below” and variations thereof and other terms of orientation are made for convenience, but does not require any particular orientation of the components. The terms of degree such as “substantially,” “about” and “approximate,” and any derivatives, as used herein mean a reasonable amount of deviation of the modified term such that the end result is not significantly changed. For example, these terms can be construed as including a deviation of at least +/−-5% of the modified term if this deviation would not negate the meaning of the word it modifies.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A vending machine having an interior product holding area comprised of a at least one product holding compartment, a product dispensing mechanism positioned at a bottom of the at least one product holding compartment, the product dispenser mechanism comprising:
a support member extending across and adjacent a lower portion of each of front and rear portions of the product holding area, each support member including a roller support;
a product dispensing roller being rotationally supported in the roller support in the front and rear support members;
a roller drive assembly attached to one of the front or rear support members and operatively connected to the product dispensing roller; and
the product dispensing roller including a product holding pocket.

2. A vending machine having an interior product holding area comprised of a plurality of adjacent, spaced apart product holding compartments, a product dispensing mechanism positioned at a bottom of each of the plurality of product holding compartments, the product dispenser mechanism comprising:
a support member extending across and adjacent a lower portion of each of front and rear portions of the product holding area, each support member including a plurality of spaced apart roller supports;
a plurality of product dispensing rollers with each being rotationally supported in the front and rear support members;
a roller drive assembly attached to one of the front or rear support members and operatively connected to each of the plurality of product dispensing rollers;
each of the plurality of product dispensing rollers including a plurality of axially adjacent product holding pockets with each pocket having an opening that is spaced circumferentially from an opening to the other pockets.

3. The vending machine dispenser as in claim 2 wherein each of the plurality of spaced apart roller supports comprises an aperture.

4. The vending machine as in claim 2 wherein at least one roller support in the front and rear support member rotatably supporting a product dispensing roller includes first and second apertures.

5. The vending machine dispenser as in claim 4 wherein the first aperture is an upper opening having a first diameter, and the second is a reduced diameter lower opening.

6. The vending machine dispenser as in claim 3 wherein the at least one of the apertures in the front or rear product support member comprises a keyhole shaped aperture.

7. The vending machine dispenser as in claim 6 wherein each aperture in each of the front and rear support members comprises a keyhole shaped aperture.

8. The vending machine dispenser as in claim 2 wherein the roller includes two axially spaced product supporting pockets.

9. The vending machine dispenser as in claim 8 wherein each of the two pockets have openings that are circumferentially spaced about 180° apart.

10. The vending machine dispenser as in claim 8 further including a spring clip positioned internally within each of the two pockets at a location adjacent each end thereof.

11. The vending machine dispenser as in claim 10 wherein each of the two pockets can receive and dispense a plurality of can products.

12. The vending machine dispenser as in claim 11 wherein each product holding compartment includes a depending dispensing delay holding flap located to span along a selected axial portion of the product dispensing roller.

13. The vending machine dispenser as in claim 12 wherein the
middle section of the depending dispensing delay holding flap spans a central portion of the axial length of the product dispensing roller.

14. The vending machine dispenser as in claim 1 wherein each roller support comprises and aperture.

15. The vending machine as in claim 1 wherein at least one roller support in the front and rear support member rotatably supporting a product dispensing roller includes first and second apertures.

16. The vending machine in dispenser as in claim 15 wherein the first aperture is an upper opening having a first diameter, and the second is a reduced diameter lower opening.

17. The vending machine dispenser as in claim 14 wherein the at least one of the apertures in the front or rear product support member comprises a keyhole shaped aperture.

18. The vending machine dispenser as in claim 17 wherein each aperture in each of the front and rear support members comprises a keyhole shaped aperture.
